(19) United States
(12) Patent Application Publication
(10) Pub. No.: US 2024/0017637 A1
(43) Pub. Date: Jan. 18, 2024

(54) CHARGING CONTROL MODULE, CHARGING STATION, AND CHARGING SYSTEM FOR CONTROLLING CHARGING PROCESSES OF TRACTION ENERGY STORAGE MEANS FOR ELECTRIC VEHICLES

(71) Applicant: PHOENIX CONTACT E-MOBILITY GMBH, Schieder-Schwalenberg (DE)

(72) Inventors: Christian SANDER, Doerentrup (DE); Markus ROSE, Schlangen (DE); Thorsten TEMME, Hannover (DE)

(21) Appl. No.: 18/256,215

(22) PCT Filed: Nov. 18, 2021
(86) PCT No.: PCT/EP2021/082099

§ 371 Date: Aug. 25, 2023

(30) Foreign Application Priority Data
Dec. 10, 2020 (DE) 10 2020 132 915.6

(51) Int. Cl. B60L 53/66; B60L 53/16; B60L 53/67; B60L 53/62

(52) U.S. Cl. CPC B60L 53/66; B60L 53/16; B60L 53/67; B60L 53/62

(57) ABSTRACT

A charging control module for controlling a charging process of a traction energy storage means at a charging point for an electric vehicle includes: a housing mounted or mountable on a carrier rail; a first data interface situated on or in the housing for exchanging data relating to the charging process with a central function for a plurality of charging control modules; and a control unit situated in the housing for controlling the charging process of the traction energy storage means depending on the data relating to the charging process that are exchanged with the central function via the first data interface.

### CROSS-REFERENCE TO PRIOR APPLICATIONS

This application is a U.S. National Phase application under 35 U.S.C. § 371 of International Application No. PCT/EP2021/082099, filed on Nov. 18, 2021, and claims benefit to German Patent Application No. DE 10 2020 132 915.6, filed on Dec. 10, 2020. The International Application was published in German on Jun. 16, 2022 as WO/2022/122334 under PCT Article 21(2).

### FIELD

The invention relates to a charging control module for a charging point of a traction energy storage means of an electric vehicle, a charging station comprising a plurality of charging points, and a system comprising a plurality of charging stations.

### BACKGROUND

In electrical engineering, a charging station is any stationary device or electrical system that is used to supply power to mobile battery-operated devices, machines or motor vehicles by simple setting or plugging in, without having to remove the energy storage means, for example the traction battery of an electric car. Charging stations for electric cars are also referred to colloquially as “electric gas stations” and can comprise a plurality of charging points. Depending on the design, charging stations can also be referred to as “charging posts.”

In the prior art, charging stations for electric vehicles are conventionally designed such that one or more electric vehicles can be charged at a charging station. For this purpose, a control technology is used that has functions that are required for each charging point (e.g. communication with the vehicle, energy measurement, control of the plug lock, etc.) and functions that are required only once per charging station (e.g. communication with a billing system, operator interface, etc.). Examples of the conventional structure are a charging controller for a charging point in which all functions are integrated; a charging controller for a double charging point in which all necessary functions are integrated; two separate, technically similar charging controllers for a double charging point, which are connected to one another as master and slave; and two charging controllers for charging processes with an additional higher-level controller for centrally used functions.

Document DE 10 2018 116 947 A1 describes a vertical “drawer” for a charging column. This mechanism comprises an electrically insulating vertical carrier plate mounted on horizontal rails for moving out a door arranged on one side of the charging column. The carrier plate extends a creepage and air path of a cable rail shaft on the interior rear wall of the charging column, while a charging column controller is mounted on the front side of the carrier plate. The actual power electronics are accommodated externally in another unit due to lack of installation space. According to the teaching of the document, it is difficult to adopt a construction that corresponds to the control cabinet construction usual in electrical engineering.

Document DE 10 2017 214 071 A1 describes a method for charging an electric vehicle in which a external data center (a so-called “cloud”) is connected to a charging station via WLAN or Ethernet and is connected to the electric vehicle via WLAN or mobile radio, without any direct data connection between the charging station and the electric vehicle. The charging process is controlled by the data center on the basis of the charging demand parameters provided by the electric vehicle via the data connection to the “cloud.”

In order to interconnect charging points and thus create a double charging point, for example, wiring by means of lines and optionally a complex connection to an industrial PC or the like is necessary for the higher-level controller. This leads to functions sometimes being present more than once in installations, but being needed only once.

### SUMMARY

In an embodiment, the present invention provides a charging control module for controlling a charging process of a traction energy storage means at a charging point for an electric vehicle, comprising: a housing mounted or mountable on a carrier rail; a first data interface situated on or in the housing and configured to exchange data relating to the charging process with a central function for a plurality of charging control modules; and a control unit situated in the housing and configured to control the charging process of the traction energy storage means depending on the data relating to the charging process that are exchanged with the central function via the first data interface.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic representation of a charging control module (for example a “slave module”) according to a first embodiment in a first side view;

FIG. 2 is a schematic representation of a charging control module according to the first embodiment (for example a “slave module”) of FIG. 1 or a second embodiment (for example a “master module”) of FIG. 3 in a second side view rotated by 90 degrees relative to the second side view in FIG. 1 or FIG. 3;

FIG. 3 is a schematic representation of a charging control module (for example a “master module”) according to a second embodiment in a first side view;

FIG. 4 is a schematic representation of an exemplary embodiment of a charging system comprising a plurality of charging stations, wherein each charging station comprises a charging control module according to the second embodiment (for example a “master module”) of FIG. 3 and one or more charging control modules according to the first embodiment (for example one or more “slave modules”) of FIG. 1; and

FIG. 5 is a schematic representation of a development of the charging control module (for example the “slave module”) according to the first embodiment in a front view.

### DETAILED DESCRIPTION

In an embodiment, the present invention provides a resource-efficient technique for constructing a plurality of charging points. In an embodiment, the invention provides a charging control module, a charging station comprising a plurality of charging control modules, and a charging system comprising a plurality of charging stations, which make it possible to equip and/or expand a parking lot or a parking facility, for example an underground garage or a multi-storey car park, with a plurality of charging points in such a way that both a central charging system and a decentrally distributed charging system are made possible. In an embodiment, the invention provides a charging system architecture that is modular and easily configurable with regard to construction, maintenance, expansion and/or replacement of individual components.

Exemplary embodiments of the invention are described below with partial reference to the figures.

According to a first aspect, a charging control module is provided for controlling a charging process of a traction energy storage means at a charging point for an electric vehicle. The charging control module comprises a housing which is or can be mounted on a carrier rail. The charging control module further comprises a first data interface, which is situated on or in the housing. The first data interface is designed to exchange data relating to the charging process with a central function for a plurality of charging control modules. Furthermore, the charging control module comprises a control unit, which is situated in the housing. The control unit is designed to control the charging process of the traction energy storage means depending on the data relating to the charging process that are exchanged via the first data interface with the central function.

The control unit can comprise a current control unit for controlling a charging current. The current control unit can be connected to an electrical plug contact. The electrical plug contact can be designed as a charging plug (plug for short). The electrical plug contact can be designed for a direct current connection or an alternating current connection between the charging point and the traction energy storage means of the electric vehicle (for example for charging or discharging the traction energy storage means).

The plug can be designed according to the IEC 62196 type 2 standard or according to the Combined Charging System (CCS).

In addition to load contacts for conducting the charging current, the electrical plug contact can comprise one or more signal contacts, for example for a “pilot control” (PC) signal and/or for a “proximity pilot” (PP) signal. The current control unit can be electrically conductively connected (for example exclusively) to the signal contacts of the electrical plug contact. Alternatively or additionally, the load contacts of the electrical plug contact can be electrically conductively connected to a charging contactor controlled by the current control unit.

A charging station (for example a charging column) can comprise one charging point or a plurality of charging points (for example two, three or four charging points). Each charging point can be assigned to a charging control module within the charging station (for example the charging column). The charging control module and/or the assigned charging point can be designed for conductive charging, for example according to the DIN EN 61851-1 standard.

The charging station or one of the charging stations or each charging station can be designed as a charging column.

The charging control module (for example the control unit) can be designed to control charging-point-specific steps or functions (also referred to as “decentral functions”) of the charging process (for example to regulate them in bidirectional communication with the electric vehicle or a battery management system, BMS, of the traction energy storage means). Alternatively or additionally, the central function for the plurality of charging control modules can control steps or functions (also referred to as “central functions”) of the charging process, for example, that are not necessarily assigned to a single charging point and/or that are not required at the same time as a plurality of charging points of the same charging station.

Decentral functions of a charging process can comprise at least one of the following functions: control of the charging current, for example control (also: contactor control) of a charging contactor (for example a contactor of the charging current); measurement of a differential current (for example at or over the electrical plug contact); control and/or reading of a differential current measuring device for measuring the differential current; control and/or monitoring of a locking actuator; measurement of energy stored in the traction energy storage means and/or energy transmitted to the traction energy storage means during the charging process; control and/or reading of an energy measuring device for measuring the energy stored in the traction energy storage means and/or the energy transmitted to the traction energy storage means during the charging process; contactless or non-contact detection of an identifier (for example the electric vehicle or a user of the charging point); and/or control or reading of an identifier detection device for detecting the identifier (i.e., for identification), for example by means of electromagnetic waves (preferably by means of near-field communication).

The identifier detection device can also be referred to as a radio-frequency identifier or RFID reader.

The differential current can comprise a leakage current or a fault current. A differential current measuring device can also be referred to in technical terms as a residual current monitor (RCM).

The control unit can be designed to forward data and/or control signals of one or more decentral functions to the current control unit. For example, the control unit can send a “stop” signal to the current control unit to interrupt and/or terminate the charging process when a predetermined threshold of a differential current is exceeded and/or when the traction energy storage means of the electric vehicle has reached a predetermined state of charge (also: fill level, for example: “full”).

Alternatively or additionally, the control unit can be designed to forward data and/or control signals of the central function to the current control unit. For example, the control unit can send to the current control unit a signal for enabling the charging process (i.e., to start the charging process).

Alternatively or additionally, the central function (for example the central functions) of a charging process can comprise a user interface (also referred to as an “operating interface”) and/or the RFID reader and/or a billing system. For example, a target value of the state of charge (for example: “full”) of the traction energy storage means of the electric vehicle can be predefined via the user interface for the termination of the charging process. Alternatively or additionally, the target value of the state of charge, for example an amount of current (or electrical charge) or energy (optionally based on a predetermined payment amount and a power price), can be captured at the user interface. Further alternatively or additionally, a time profile and/or a current intensity (which is for example dependent on the time of the charging process and/or the state of charge of the traction energy storage means) for controlling the charging process can be determined by the central function and/or communicated to the control unit of the charging control module. For example, a maximum charging time for the traction energy storage means of the electric vehicle can be determined via the user interface. Alternatively or additionally, charging currents for a plurality of charging points arranged at a charging station or charging column can be determined on the basis of a maximum total charging current. The total charging current can be the sum of the charging currents of all charging points at a charging station or charging column. The maximum total charging current can be predefined for the charging station or charging column.

A charging control module comprising only decentral functions, can also be referred to as a “slave module.” Alternatively or additionally, a charging control module comprising (for example at least in partly and/or at least some of a set of) central functions can be referred to as a “master module.” Further alternatively or additionally, a charging station or charging column can comprise a plurality of slave modules and one master module.

The first data interface can comprise a data interface between one or each slave module and the master module, for example a data interface on the slave module for exchanging data with the master module.

The first data interface of a slave module can be arranged on the housing. Alternatively or additionally, the first data interface of the master module can be arranged in the housing (for example as an internal or virtual interface between the decentral functions of the master module and the central functions of the master module).

The master module can comprise a second data interface, for example, which is situated on the housing of the master module. The second data interface of the master module can be designed to communicate with the first data interface of one or each slave module (for example of the same charging station).

The master module can be structurally identical to a slave module. In a slave module, the decentral functions can be activated and the central functions can be deactivated. The decentral and (for example at least a part of the) central functions can be activated in the master module. Alternatively or additionally, the master module can comprise further components and/or central functions in addition to the components and/or in addition to the decentral functions of a slave module.

Alternatively or additionally, the central function can be situated (for example at least in partly) outside the charging station or charging column. For example, the central function can be central for one or more parking levels comprising a plurality of charging stations or charging columns.

Exemplary embodiments of the charging control module can allow a parking space or a parking facility, for example an underground garage or a multi-storey car park, to be equipped with a plurality of charging points for controlling charging processes of traction energy storage means of electric vehicles and/or for extending an existing charging system.

The charging control module can be used in both a central charging system (for example in a charging system controlled centrally by the system control unit) and in a decentral charging system, for example in a single charging station or charging column. The charging control modules assigned to a charging point can be arranged in a control cabinet and/or distributed over a plurality of subgroups, for example of any or different sizes. For example, the charging points of ten double chargers, each with two parking spaces, i.e., a total of twenty charging points, can be combined in a charging system and managed by a central function, in particular a system control unit, of the charging system.

Exemplary embodiments of the charging control module allow for a system architecture of a charging system comprising N charging points in which only the decentral functions that are required at each of the N charging points according to the plurality of N charging control modules are installed N times, while the central function (for example the central functions) required only once is installed only once, for example in one charging control module of the plurality of N charging control modules. For example, if there are twenty (i.e., N=20) charging points, which are arranged in ten double chargers, one master module and one slave module can be installed for each double charger. The respective master module can comprise only the components of the central function that are required locally at the double charger. Other parts of the central function, for example a billing system, can be implemented in a central system control unit.

The central system control unit can (for example via the respective master module) be in data exchange with the slave modules in order to execute or provide the central function.

If a plurality of charging points are accommodated in a charging station (for example a charging column), they can be wired to each other by means of a (for example automatic) connection. For example, the first data interface of the slave module and/or the second data interface of the master module can be arranged to come into electrical contact with the first data interface of an adjacent slave module and/or the second data interface of an adjacent master module during mounting on the carrier rail. For example, the two data interfaces can be arranged on the housing of the respective charging control module on opposite sides in a longitudinal direction of the carrier rail. The mounted charging control modules can form a data bus (for example by connecting the contacts of the data interfaces on both sides of the housing). Alternatively or additionally, the first data interface of the slave module and/or the second data interface can be arranged to come into contact with a data bus arranged on the carrier rail during mounting on the carrier rail.

The data connection (for example physical and/or logical) for exchanging data within a charging station can be established via the first data interface(s) of the slave module(s) and the second data interface of the master module, for example in case of or in response to the mounting. Alternatively or additionally, the control unit of one or each charging control module can be designed to establish a logical connection for exchanging data between the plurality of charging control modules in response to the establishment of the physical connection (for example the wiring).

Alternatively or additionally, a network for exchanging data between a plurality of charging stations or charging columns and/or a network for exchanging data between a charging station and a system control unit can also be constructed, which network(s) is/are in each case assigned to the same charging system (also referred to as “grouping”). Data communication between a plurality of charging stations and/or a system control unit can be established via the master module of the respective charging station, for example via a third data interface of the respective master module.

The housing of the charging control module can comprise a recess for mounting on the carrier rail.

The carrier rail can be or comprise a top-hat rail. The carrier rail can have a transverse dimension (for example perpendicular to the longitudinal direction of the carrier rail or a width) and/or the recess of the housing can have a transverse dimension (for example perpendicular to the longitudinal direction of the carrier rail or a width) of 35 mm.

The carrier rail can comprise a data bus. The first data interface (for example the slave module) and/or the second data interface (for example the master module) can be designed to come into contact with the data bus for exchanging data with the central function when the housing is mounted on the carrier rail.

The exchange of data can also be referred to as data communication.

The data bus or the data connection can comprise a serial bus and/or a differential bus, for example for symmetrical signal transmission. The differential bus can be a controller area network bus (CAN bus).

The control unit can comprise a current control unit designed to control a charging current of the traction energy storage means during the charging process in response to or in accordance with the exchanged data from the central function.

The current control unit can be designed to control the charging current according to a specification of the central function in the data received from the central function via the first data interface. The specification can comprise an enabling of the charging current and/or an identifier of the electric vehicle enabled for charging.

The current control unit can be designed to control a direct current and/or an alternating current as the charging current.

The control unit can comprise a locking controller. The locking controller can be designed to control an actuator of a locking mechanism of a charging plug assigned to the charging point according to the central function between a locked position of the charging plug and an unlocked position of the charging plug.

The charging point can comprise the charging plug and/or a holder of the charging plug arranged on a charging cable. Alternatively or additionally, the locked position of the charging plug and/or the unlocked position of the charging plug can comprise a position of the charging plug on the charging point and/or in the holder on the charging point and/or a position of the charging plug arranged on a charging cable on an electric vehicle.

The actuator of the locking mechanism can also be referred to as a locking actuator.

The charging control module can further comprise (for example at least in part) the central function for a plurality of charging control modules. The plurality of charging control modules can comprise the charging control module comprising the (for example at least in part) central function and at least one further charging control module without the central function. The charging control module comprising the (for example at least in part) central function can comprise a second data interface arranged on the housing. The second data interface can be connected or can be connectable to the first data interface of the at least one further charging control module, for example directly or via a data bus. The second data interface can be designed to exchange the data relating to the charging process of the at least one further charging control module with the central function.

The charging control module comprising the (for example at least in part) central function can be referred to as the master module. A master module and one or more slave modules can be arranged on a charging station or charging column, for example corresponding to the plurality of charging control modules. The master module can also be referred to as a charging station control module or charging column control module.

The carrier rail can comprise a data bus. The second data interface of the charging control module comprising the (for example at least in part) central function can be designed to come into contact with the data bus for exchanging data with the at least one further charging control module when the housing is being mounted on the carrier rail.

The charging control module comprising the (for example at least in part) central function can further comprise a third data interface. The third data interface can be designed to communicate with a user interface, a control unit of the electric vehicle and/or a system control unit of a charging system comprising a plurality of charging stations. Each charging station can comprise at least one charging control module comprising the (for example at least in part) central function.

The third data interface can be or comprise a wireless communication interface. For example, the third data interface can be or comprise a mobile radio interface, a radio interface of a local radio network (for example a so-called wireless local area network, WLAN, according to the Wi-Fi Alliance) and/or a radio interface of a direct radio connection or point-to-point connection (for example a Bluetooth interface according to the Bluetooth Special Interest Group).

The user interface can comprise a mobile terminal (for example of a driver of the electric vehicle). The communication can take place via the mobile terminal (for example a mobile telephone, a smart phone and/or a tablet computer) and/or via a user interface in the electric vehicle.

The control unit of the electric vehicle can comprise a battery management system (BMS) of the traction energy storage means.

The control unit of the master module can be designed by means of the third data interface to perform a load distribution (also: load management) of the charging currents (for example in communication with the system control unit), a user data comparison (for example a user authorization) and/or a user data query (for example in communication with the user interface or the RFID reader), a system status query (for example in communication with the system control unit), a charging release query (for example by a billing system) and/or an output on a display (for example in communication with the user interface).

Alternatively or additionally, the third data interface can comprise a display (for example on the charging station).

In this case, lists of the form A, B and/or C comprise at least one element of the set A, B and C. Lists of the form A, B and/or C can be read as lists of the form A and/or B and/or C.

According to a second aspect, a charging station having a plurality of charging points is provided for an electric vehicle in each case. The charging station comprises a carrier rail. Furthermore, the charging station comprises a plurality of charging control modules that are mounted on the carrier rail and correspond to the plurality of charging points. The plurality of charging control modules comprises a charging control module (designed for example as a master module) having a (for example at least in part) central function and at least one further charging control module (for example designed as a slave module).

For example, the plurality of charging control modules can comprise at most one charging control module having a (for example at least in part) central function. Alternatively or additionally, all further charging control modules of the plurality of charging control modules can be designed without the central function.

The charging station can be designed as a charging column.

The charging control modules can be mounted or mountable in a row on the carrier rail. For example, the charging control module having a (for example at least in part) central function can be mounted first in the row on the carrier rail. The sequence can relate to a data connection to the outside, for example to a central system control unit of a charging system comprising a plurality of charging stations.

The carrier rail can comprise a data bus.

The first data interface of a charging control module (for example designed as a slave module) can be connected to the data bus of the carrier rail. Alternatively or additionally, the first data interface of a charging control module (for example designed as a slave module) can be directly connected to the first data interface of the charging control module (for example designed as a slave module). The direct connection can be provided, for example, via adjacent sides of the housings of adjacent charging control modules.

The first data interface of a charging control module (for example designed as a master module), which comprises the (for example at least in part) central function of the charging station or charging column, can be situated within the housing (for example as an internal or virtual interface between the slave functions of the master module and the, for example at least in part, central function).

The second data interface of a charging control module (for example designed as a master module) comprising the (for example at least in part) central function can be connected to the data bus of the carrier rail. Alternatively or additionally, the second data interface of the charging control module (for example designed as a master module) comprising the (for example at least in part central function) can be directly connected to the first data interface of an adjacent charging control module (for example designed as a slave module). The direct connection can be provided, for example, via adjacent sides of the housings of adjacent charging control modules.

The carrier rail can be designed as a top-hat rail.

A transverse dimension of the carrier rail and/or top-hat rail can comprise 35 mm.

The plurality of charging control modules can be mounted in a row on the top-hat rail. For example, the master module can be mounted first in the row of modules on the top-hat rail followed by one or more slave modules. A sequence of charging control modules can relate to a data connection to a central system control unit of a charging system comprising a plurality of charging stations.

The carrier rail can comprise a data bus for exchanging data between the second data interface of the charging control module with the (for example at least in part) central function and the at least one first data interface of the at least one further charging control module without a central function.

The data bus can comprise a CAN bus integrated in a top-hat rail.

The charging station can further comprise a base plate. The carrier rail can be fastened to the base plate.

The base plate can be arranged in the charging station or charging column so as to be movable (for example longitudinally movable and/or movable along a direction parallel to the base plate). For example, the base plate can be removable (for example longitudinally movable and/or movable along a direction parallel to the base plate) from an operating position (also called working position) in the charging station or charging column for maintenance purposes and/or mounting purposes.

According to a third aspect, a charging system is provided. The charging system comprises a system control unit. The charging system further comprises a plurality of charging stations. The plurality of charging stations is (for example in each case) designed to be in data connection with the system control unit.

The plurality of charging stations can be situated on one or more levels of a parking facility, for example of a multi-story car park.

The data connection between the plurality of charging stations and the system control unit can comprise an Ethernet connection and/or a wireless connection (for example via a WLAN system of the parking facility).

The system control unit can detect identifiers of the charging control modules of the plurality of charging stations via the data connection.

An identifier of a charging control module can comprise a device address (also called a “hardware address,” for example a media access control address, or “MAC address” for short) of a charging control module. Alternatively or additionally, an identifier of a charging station can comprise the device address of the master module of the charging station.

Preferably, the system control unit (for example on the basis of the respective identifier of the charging control module) can detect an arrangement of the charging control modules and/or an assignment of the charging control modules to a charging point in each of the plurality of charging stations via the data connection.

The arrangement of the charging control modules can also be referred to as the topology. The system control unit can detect a change in the topology (for example automatically, in particular without manual input by a system administrator), for example during replacement of a charging control module. For example, by means of a data bus integrated in a carrier rail of a charging station, a replacement of a charging control module can be detected by means of monitoring the data bus complementary to the first data interface (for a slave module) and/or to the second data interface (for the master module) a replacement of a charging control module being detected by means of a temporary interruption of a data connection. A temporary interruption of the data connection at a data interface of the data bus can be communicated to the system control unit together with the identifier of the charging station (for example by means of the device address of the master module of the charging station).

The system control unit can be designed to configure all charging control modules or a replaced charging control module (for example, one that is mounted for the first time) on the basis of a detected topology or in response to a change in the topology. The configuration can comprise sending a configuration message from the system control unit to the respective charging control module (for example via the master module to a slave module). Alternatively or additionally, the configuration of a charging control module can comprise configuring the control unit of the respective charging control module, for example configuring the control unit of the respective charging control module to perform the decentral functions. The configuration message can comprise parameters of the decentral functions. This eliminates the need for a system administrator to manually enter the configuration on the respective charging control module.

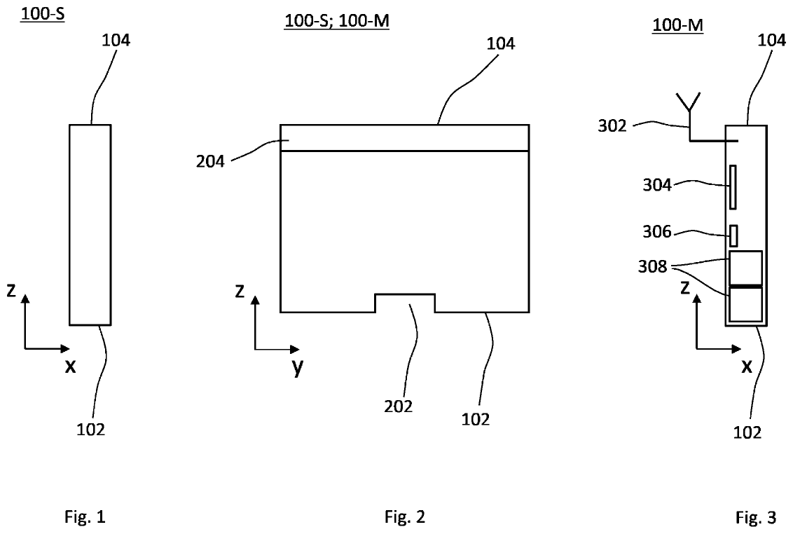

FIG. 1 shows a charging control module according to a first embodiment of the invention in a first side view. The charging control module according to the first embodiment is generally denoted by reference sign 100-S.

The charging control module 100-S comprises a housing. The charging control module 100-S can be mounted on a carrier rail with a first housing side 102, for example by means of a detent or locking mechanism. A second housing side 104 faces away from the first housing side 102 and/or the detent for the carrier rail. The first housing side 102 and the second housing side 104 each extend in an xy plane (wherein the y-axis is not shown in FIG. 1). The first housing side 102 and the second housing side 104 are spaced apart from one another along a z-direction.

A longitudinal direction of the carrier rail can have along the x-axis. A transverse dimension of the carrier rail can have a y-axis perpendicular to the x-axis and the z-axis.

The embodiment of a charging control module 100-S shown in FIG. 1 comprises decentral functions. The charging control module 100-S can also be referred to as a “slave module.”

FIG. 2 shows the charging control module 100-S in a second side view, rotated by 90 degrees about a vertical axis (z-axis) with respect to the first side view in FIG. 1. A recess 202 having a detent or locking mechanism for mounting on a carrier rail is located on the first housing side 102. The recess 202 (for example the detent or locking mechanism) can comprise a first data interface 202. For example, the first data interface 202 can comprise a bus connection and/or a printed circuit board direct connector (abbreviated as PCB direct connector).

In the embodiment of FIG. 2, a connection region 204 for decentral functions, which can also be referred to as peripheral components, is located on the second housing side 104. The decentral functions can comprise a digital input/output (also abbreviated as I/O) interface, a differential current meter (also called an RCM module), a socket outlet or a plug-in connection, an energy meter and/or an RFID reader.

FIG. 3 shows a charging control module according to a second embodiment of the invention. The charging control module according to the second embodiment is generally denoted by reference sign 100-M. The charging control module 100-M has a first building side 102 for mounting on a carrier rail (for example with a longitudinal extension of the carrier rail along the x-axis). The charging control module 100-M further comprises a second building side 104 that faces away from the first building side 102 and is spaced apart along the z-axis.

The charging control module 100-M comprises a third data interface that can have different embodiments. FIG. 3 shows by way of example an antenna 302 via which a mobile radio connection (for example via a mobile radio network according to one of the 3G, 4G or 5G standards of the 3rd Generation Partnership Project, 3GPP, via a local WLAN and/or via Bluetooth) can be established with a user, a charging system controller (also called a system control unit) and/or a cloud.

The charging control module 100-M can also optionally comprise one or more of the terminals identified by reference signs 304, 306 for a serial bus system (for example a universal serial bus, USB), a card with a subscriber identity module (SIM) and/or a secure digital memory card (SD card).

The charging control module 100-M can also optionally comprise at least one terminal 308 for a wired data connection. In the exemplary embodiment of FIG. 3, the charging control module 100-M comprises two Ethernet interfaces, which can be designed as RJ 45 type sockets.

The antenna 302, the terminals 304, 306, and/or the wired data interfaces 308 may be referred to as the third data interface.

The charging control module 100-M comprises both decentral and central functions. The charging control module 100-M can also be referred to as a “master module.”

A side view of the charging control module 100-M (for example designed as a master module) rotated by 90 degrees along the z-axis can correspond to a side view of the charging control module 100-S in FIG. 2 (designed for example as a slave module). In the charging control module 100-M, the recess 202 and/or detent 2020 can comprise a second data interface 202, which is designed to exchange data with the first data interfaces 202 of the slave modules 100-S. The first data interface of the master module 100-M can be arranged as a virtual interface between decentral functions and central functions within the housing of the charging control module 100-M.

The housing can be an existing housing configured to receive or house any electrical assemblies, in particular charging control modules 100-S or 100-M of one or each embodiment disclosed herein.

The carrier rail can comprise a bus adapter (for example a top-hat rail bus adapter) as a data bus. Via the data bus, there can be a first data connection between charging control modules 100-S and 100-M and/or (for example indirectly via master module 100-M), a second data connection between charging stations and/or (for example indirectly via master module 100-M) a third data connection between a charging control module 100-S or 100-M and a system control unit. As a result, a (for example automatic) data connection can be established during the course of mounting.

The top-hat rail bus adapter can be adapted to a housing series. The housings (for example of the same housing series for a charging station or charging column and/or for a charging system) can be mounted together, for example in a row, on a carrier rail 35 mm wide, together with the bus adapters (also referred to as carrier rail bus connectors). The carrier rail can in turn be mounted on a base plate of a control cabinet in a charging station or charging column.

Each charging control module 100-S, 100-M can control a charging point and/or be assigned to a charging point. At the charging point, one or all necessary additional components can be present and/or connected to charge with alternating current (abbreviated as AC) and/or direct current (abbreviated as DC), for example the RCM module, the locking actuator, the charging contactor, the RFID reader and/or the energy meter.

The charging system or the charging station comprises charging control modules (for example slave modules 100-S), which only implement the charging-point-specific (i.e., decentral) functions (for example in the respective control unit) that are assigned to a charging point, and at least one charging control module (for example master modules 100-M) that, in addition to the decentral functions, also has functions that are assigned to the charging station or charging column as a central system (also referred to as an “overall system”), preferably for data communication with the system control unit (for example a parking facility comprising a plurality of charging stations and/or for data communication with one or more billing systems).

Each charging point can be operable both autonomously and in the system network (for example within a charging station or charging column or within a charging system comprising a plurality of charging stations).

The charging points can be connected to one another within a charging station or a charging column via a differential bus, in particular a CAN bus, for example via the bus adapters in the sense of the first data connection between the first and the second data interface.

Charging points of various charging stations or charging columns, in particular charging points in a plurality of charging stations within a parking facility, can be connected to one another via the first, second and/or third data interfaces. FIG. 3 shows an antenna 302, a card receptacle 304, a USB port 306, Ethernet interfaces 308, in each case as a possible embodiment of the third data interface for establishing the second or third data connection.

For example, a plurality of multi-story car park levels or charging stations having two, three and/or four charging points (also referred to as “double islands”, “triple islands” and/or “quadruple islands”) can be connected to a charging system (also referred to as an overall system) and controlled and/or managed.

A control unit of a charging control module (for example a master module) 100-M comprising the (for example at least in part) central function and/or a system control unit (also referred to as a “charging controller in the system”) of a charging system can form a data interface to the outside (for example relative to a charging station or charging column). The control unit of the master module 100-M and/or system control unit can distribute, regulate and/or control all information and/or functions related to charging processes at the charging station and/or in the overall system. The information and/or functions can comprise, for example, load management, user authorization, billing data routing and/or billing data display and/or system status representations. A system status can relate to one or each charging point of a charging station or charging column and/or to a plurality of charging stations and/or charging columns, for example in a parking facility.

The charging control module (“master module”) comprising the (for example at least in part) central function is freely selectable. For example, the master module can be arranged as a first charging control module on the top-hat rail followed by further charging control modules (“slave modules”) without a central function.

Functions that can be assigned to one, two or more charging points depending on the design (for example, an RFID reader can be assigned to two charging points), can be assigned to the system via a configuration of a particular group of charging points. The configuration can be carried out, for example, by a system control unit of a charging system. In particular, the configuration can be effected without manual input (for example by a system administrator).

The charging control module (also: master module) comprising the (for example at least in part) central function can be identical to the further charging control modules (also referred to as slave modules) without a central function. Alternatively or additionally, the master module and the slave module can differ in that the slave module provides only the (for example decentral) functions that are required to implement the assigned charging point.

The charging control modules according to the invention (for example master module 100-M and slave module 100-S) can (for example within a charging station or charging column) be connected to one another in a corresponding manner. Alternatively or additionally, the charging system according to the invention allows system formation without active (for example manual) configuration by a user and/or system administrator. Exemplary embodiments may allow automatic configuration of the charging system. The use of identical hardware components, for example for slave modules 100-S and master modules 100-M, allows for a simple and cost-effective modular structure and/or removal as well as maintenance (for example replacement of a single charging control module in the event of a fault and/or after a defined operating time and/or service life of the charging control module).

The charging stations and/or the charging control modules of a charging system can be automatically linked to a network via a local backplane bus (for example integrated in the carrier rail) as the first data connection and/or via Ethernet as the second data connection.

The topology of the combined charging system and/or network (for example comprising the assignment of charging control modules to charging points) can be detected automatically (for example without manual input by a system administrator). Alternatively or additionally, a replacement of charging control modules without (for example, manual) reconfiguration is possible. For example, a master module 100-M of a charging station and/or the system control unit of a charging system comprising a plurality of charging stations can store the configuration of one or each slave module 100-S (for example, each slave module 100-S that is assigned to the charging station and/or the system control unit).

Exemplary embodiments of the invention allow an assignment of central functions (abbreviated as central function) and decentral functions, which can be assigned both to a charging station having N charging points and to a charging point by configuration (also referred to as 1:1 assignment, 1:2 assignment, . . . , 1:N assignment, wherein N is a natural number greater than 1). In this case, the configuration can comprise receiving configuration parameters (for example transferred from the central function) on the slave module 100-S.

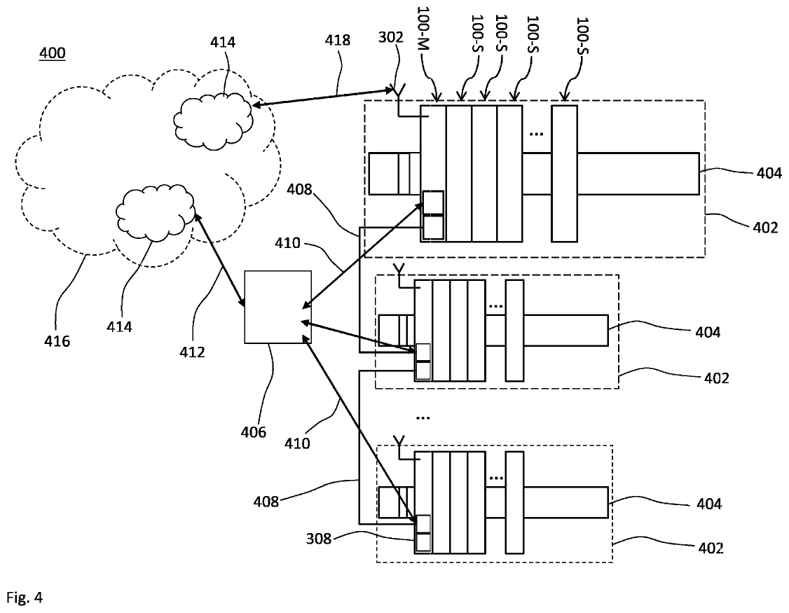

FIG. 4 shows an embodiment of a charging system generally denoted by reference sign 400.

The exemplary charging system 400 in FIG. 4 comprises a plurality of (for example three) charging stations 402, which can also be designed as charging columns 402. Each charging station 402 or charging column 402 comprises a master module 100-M and one or more slave modules 100-S that are mounted in a row on a carrier rail 404, for example a top-hat rail. The master module 100-M and the slave modules 100-S are connected to one another via a data connection integrated in the carrier rail 404. The data connection can comprise a first data interface of the slave modules 100-S and a second data interface of the master module 100-M.

Furthermore, the master modules 100-M of the charging stations 402 in the charging system 400 of FIG. 4 are connected to a system control unit 406 via at least one third data interface, for example according to any one of the features 302, 304, 306 and/or 308.

The data connection between the master modules 100-M and the system control unit 406 can comprise an (in particular direct) wired connection 410, for example an Ethernet connection of each master module 100-M to the system control unit 406. Alternatively or additionally, a wired connection can comprise (for example indirect) Ethernet connections 408 of the master modules 100-M of a plurality of charging stations 402 to one another and an (in particular direct) Ethernet connection 410 of a master module 100-M to the system control unit 406.

The third data interface can be implemented by means of an antenna 302 with a radio modem; a SIM card or SD card receptacle 304; a USB port 306 and/or an Ethernet interface 308.

Alternatively or additionally, the second data connection 408 between the master modules 100-M and/or the third data connection 410 of the master modules 100-M with the system control unit 406 can be wireless. In the embodiment of the charging system 400 shown in FIG. 4, a master module 100-M can be connected via wireless data connection 418 to a computer network 416 (for example the Internet), which can be referred to as a “cloud” and can comprise a plurality of sub-networks 414 for data exchange. The system control unit 406 can also be connected to the cloud 416 via a wireless connection 412.

According to a first exemplary embodiment, which can be combined with any embodiment disclosed herein and/or any exemplary embodiment disclosed herein, the charging control module 100 (for example the control unit thereof) comprises access (for example by means of the third data interface) to publicly accessible software or source codes (“open source support”), for example, access to a digital distribution platform for application software (“application store” or “AppStore” for short) and/or a free communication standard for charging points (“open charge point protocol,” abbreviated as OCPP).

The charging control module 100 according to the first exemplary embodiment is connected to cloud services. The cloud services can be associated with an operator and/or a service provider and can comprise backup software and/or a local (also known as “patch”) controller. The charging control module according to the first exemplary embodiment further comprises a local load controller and energy management. The charging control module comprises equipment for use in a smart grid according to IEC 61850, a smart home by means of EEBUS, a vehicle-to-grid (V2G) according to ISO 15118, a cellular connection according to 4G and/or 5G, an Ethernet connection (for example in a wide area network, abbreviated as WAN, and/or a local area network, abbreviated as LAN) and/or a USB “on the go” (USB-OTG) connection.

According to a second exemplary embodiment, which can be combined with any embodiment disclosed herein and/or any exemplary embodiment disclosed herein, a charging control module is designed for AC charging according to the 61851-1 standard. The charging control module according to the second exemplary embodiment comprises a V2G connection according to ISO 15118, a locking control and automatic unlocking with power loss. The charging control module according to the second exemplary embodiment further comprises a contactor (for example for 230 V), a direct current RCM module (for example for 6 mA), an RFID reader, an energy meter and multiple purpose digital I/Os.

According to a third exemplary embodiment, which can be combined with any embodiment disclosed herein and/or any exemplary embodiment disclosed herein, a charging station comprises a public AC charging pole, which can also be referred to as a lightpole. The charging control module of the third exemplary embodiment is fed by a DC source (for example with a DC voltage at a level of 12 V). The charging control module of the third exemplary embodiment comprises and/or is in signal connection with an RFID reader, a load current line (“mains,” comprising an alternating current), a contactor (for example for 230 V), an RMC module (designed, for example, for 6 mA) and an electricity meter.

According to a fourth exemplary embodiment, which can be combined with any embodiment disclosed herein and/or any exemplary embodiment disclosed herein, comprises a charging control module for DC fast charging, a combined charging system (abbreviated as CCS), optionally for high power charging (abbreviated as HPC).

Alternatively or additionally, the plug (also: plug connector) and/or the decentral functions (for example with respect to data communication with the electric vehicle) can be designed according to the Japanese CHAdeMO standard and/or the Chinese GB-T standard. The plug connector according to CCS, CCS-HPC, CHAdeMO and/or GB-T can further comprise a CAN bus for communication between the control unit of the charging control module 100 and the control unit of the electric vehicle.

The decentral functions can comprise control, regulation and/or reading of charging station peripherals. The charging station peripherals can comprise, for example, power electronics, insulation monitoring and/or an electricity meter. The charging control module of the fourth exemplary embodiment can further comprise, for example for controlling, regulating and/or reading according to the decentral functions, one or more serial data interfaces (for example according to one of the standards RS232, RS485 and/or CAN), a wired data interface (for example an Ethernet interface according to a transmission control protocol/internet protocol (abbreviated as TCP/IP), and/or a plug connector of the RJ 45 type and/or one or more digital I/O interfaces.

According to a fifth exemplary embodiment, which can be combined with any embodiment disclosed herein and/or any exemplary embodiment disclosed herein, the charging control modules are part of a modular system for setting up a charging system and/or a charging infrastructure for traction energy storage means for electric vehicles. The modular system makes possible a plurality of applications, in particular for an independent system (for example a single charging point) and/or connected systems (which can also generally be referred to as “master-slave” systems) having one or more charging points (for example 1 to N charging points, wherein N is a natural number greater than 1) at one charging station and/or one or more charging stations connected to one another. Alternatively or additionally, the applications of the modular system comprise AC charging standards, DC charging standards and/or multi-standard charging plugs (for example CCS, CCS-HPC and/or CHAdeMO). The modular system of the fifth exemplary embodiment can allow a rapid start-up and/or operation, in particular by means of a self-configuration of a control network and a simple configuration and/or update of each component (for example each charging control module 100-S, 100-M). The control network can comprise the system control unit 406 and/or at least one of the networks 414 or 416 of FIG. 4.

According to a sixth exemplary embodiment, which can be combined with any embodiment disclosed herein and/or any exemplary embodiment disclosed herein, the modular system of the fifth exemplary embodiment can be used, scaled and/or combined for all orders of magnitude of application cases from a single charging point to a parking facility comprising a plurality of charging stations and/or a plurality of parking facilities combined in a charging system, for example for a fleet of electric vehicles of an operator.

In each exemplary embodiment, the third data interface of the charging control module 100-M can comprise an interface according to any one of the standards IEC 61850, EEBUS, V2G ISO 15118, 3GPP Long Term Evolution (LTE) or 4G, 3GPP New Radio or 5G, Ethernet and/or USB OTG. The control unit of the charging control module 100-M can access the system control unit via the third data interface, or the control unit of the charging control module 100-S can access the system control unit indirectly via the third data interface (for example via the first and second data interfaces).

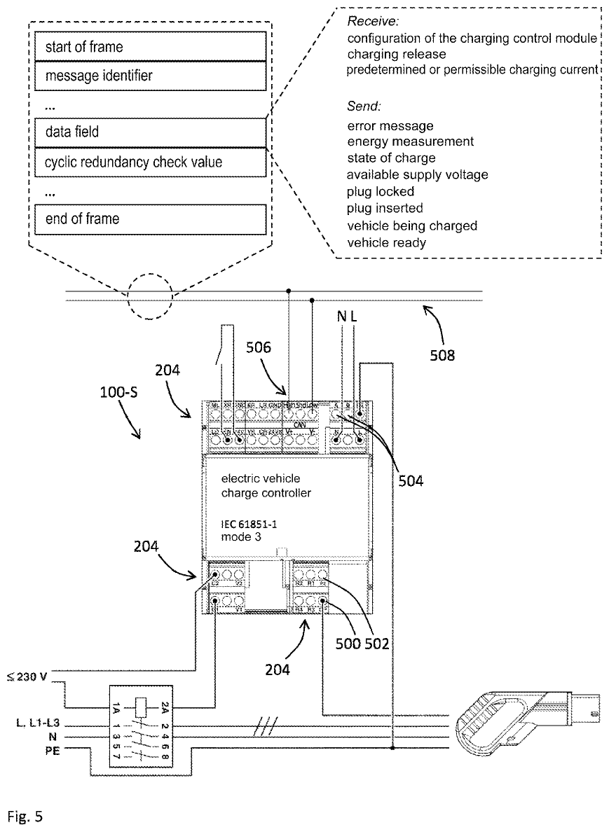

FIG. 5 shows an exemplary embodiment of the charging control module that develops the first embodiment, i.e., the slave module 100-S. The connection region 204 for the decentral functions (i.e., the charging-point-specific functions) of the control unit of the slave module 100-S can control the charging contactor (shown at lower left in FIG. 5), the communication with the electric vehicle via the charging plug (for example the control signals CP with the reference sign 500 and PP with the reference sign 502), the reading of the energy meter (for example via the serial port RS485 with the reference sign 504), the detection of a locking feedback from the locking mechanism of the plug, a monitoring of the charging contactor via auxiliary contacts, the detection of a charging release and/or the output of an error message.

Alternatively or additionally, the configuration of the charging control module 100-M can be received from the master module 100-M or the system control via the first data interface 506 for the first data connection 508 (for example a CAN bus) between charging control modules 100-S and 100-M. The configuration can specify a predetermined or permissible charging current that the control unit communicates to the electric vehicle by pulse width modulation of the control signal CP. Alternatively or additionally, the control unit of the slave module 100-S can be designed to compare the configured charging current with a current-carrying capacity encoded in the control signal PP (for example, encoded as resistance value), and to output the error message for example in the event of incompatibility between the current-carrying capacity and the charging current.

Alternatively or additionally, the control unit of the slave module 100-S receives the charging release from the master module 100-M or from the system controller.

Alternatively or additionally, the control unit of the slave module 100-S is designed to send the error message, the measured energy of the charging process, a state of charge of the traction energy storage means, the application of a supply voltage (for example as a trigger for receiving the configuration) and/or an identifier of the slave module 100-S to the master module 100-M and/or the system controller via the first data interface 506.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

List of reference signs

| charging control module as a slave module | 100-S |
|---|---|
| charging control module as a master module | 100-M |
| housing side facing the carrier rails | 102 |
| housing side away from the carrier rails | 104 |
| recess in the housing for fastening to a carrier rail, optionally | 202 |
| comprising a first or second data interface | |
| connection region for decentral functions | 204 |
| antenna, optionally as a third data interface | 302 |
| receptacle for SIM card or SD card, optionally as a third data | 304 |
| interface | |
| port for a serial bus, for example USB, optionally as a third data | 306 |
| interface | |
| Ethernet port, optionally as a third data interface | 308 |
| charging station, optionally charging column | 402 |
| carrier rail, optionally top-hat rail | 404 |
| system control unit | 406 |
| data connection between charging stations | 408 |
| data connection between charging station and system control unit | 410 |
| data connection between system control unit and computer | 412 |
| network, optionally internet access | |
| sub-network | 414 |
| computer network, optionally cloud or internet | 416 |
| data connection between master module and computer network, | 418 |
| optionally internet access | |
| control pilot (CP) signal | 500 |
| proximity pilot (PP) signal | 502 |
| port for serial bus of a decentral function | 504 |
| port for serial bus of a decentral function | 504 |
| first data interface | 506 |
| data connection between slave module and master module | 508 |

1: A charging control module for controlling a charging process of a traction energy storage means at a charging point for an electric vehicle, comprising:
a housing mounted or mountable on a carrier rail;
a first data interface situated on or in the housing and is configured to exchange data relating to the charging process with a central function for a plurality of charging control modules; and
a control unit situated in the housing and configured to control the charging process of the traction energy storage means depending on the data relating to the charging process that are exchanged with the central function via the first data interface.

2: The charging control module of claim 1, wherein the housing comprises a recess for mounting on the carrier rail.

3: The charging control module of claim 1, wherein the carrier rail comprises a data bus, and the first data interface is configured to contact the data bus to exchange the data with the central function when the housing is mounted on the carrier rail.

4: The charging control module of claim 1, wherein the control unit comprises a current control unit configured to control a charging current of the traction energy storage means during charging in response to or in accordance with the exchanged data from the central function.

5: The charging control module of claim 4, wherein the current control unit is configured to control a direct current and/or an alternating current as the charging current.

6: The charging control module of claim 1, wherein the control unit comprises a locking controller configured to control an actuator of a locking mechanism of a charging plug assigned to the charging point of the central function between a locked position of the charging plug and an unlocked position of the charging plug.

7: The charging control module of claim 1, further comprising:
the central function for a plurality of charging control modules according to claim 1, wherein the plurality of charging control modules comprises the charging control module comprising the central function and at least one further charging control module without a central function; and
a second data interface situated on the housing, the second data interface being connected or connectable to the first data interface of the at least one further charging control module, and configured to exchange the data relating to the charging process of the at least one further charging control module with the central function.

8: The charging control module claim 7, wherein the carrier rail comprises a data bus, and the second data interface is configured to contact the data bus to exchange the data with the at least one further charging control module when the housing is mounted on the carrier rail.

9: The charging control module of claim 7, further comprising:
a third data interface for communication with a user interface, a control unit of the electric vehicle, and/or a system control unit of a charging system comprising a plurality of charging stations,
wherein each charging station of the plurality of charging stations comprises at least one charging control module.

10: A charging station having a plurality of charging points in each case for an electric vehicle, comprising:
a carrier rail; and
a plurality of charging control modules mounted on the carrier rail and corresponding to the plurality of charging points,
wherein the plurality of charging control modules comprise:
a charging control module having the central function of claim 7; and
at least one further charging control module for controlling a charging process of a traction energy storage means at a charging point for an electric vehicle, comprising:
a housing mounted or mountable on a carrier rail;
a first data interface situated on or in the housing and configured to exchange data relating to the charging process with a central function for a plurality of charging control modules; and
a control unit situated in the housing and configured to control the charging process of the traction energy storage means depending on the data relating to the charging process that are exchanged with the central function via the first data interface.

11: The charging station of claim 10, wherein the carrier rail comprises a top-hat rail.

12: The charging station of claim 10, wherein the carrier rail comprises a data bus for exchanging data between the second data interface of the charging control module having the central function and the at least one first data interface of the at least one further charging control module.

13: The charging station of claim 10, further comprising:
a base plate,
wherein the carrier rail is attached to the base plate.

14: A charging system, comprising:
a system control unit; and
a plurality of charging stations of claim 10,
wherein the plurality of charging stations are configured to be in data communication with the system control unit.

15: The charging system of claim 14, wherein the system control unit is configured to acquire identifiers of the charging control modules of the plurality of charging stations via the data connection.

16: The charging system of claim 14, wherein the system control unit is configured to acquire an arrangement of the charging control modules and/or an assignment of the charging control modules to a charging point in each of the plurality of charging stations via the data connection.
